(19) United States
(12) Patent Application Publication
(10) Pub. No.: US 2024/0271910 A1
(43) Pub. Date: Aug. 15, 2024

(54) WIND SPEED DISPLAYING RETICLE SYSTEM

(71) Applicant: Plumb Precision Products LLC., Issaquah, WA (US)

(72) Inventor: Francis M. Plumb, Issaquah, WA (US)

(21) Appl. No.: 18/531,506

(22) Filed: Dec. 6, 2023

Related U.S. Application Data
(60) Provisional application No. 63/445,479, filed on Feb. 14, 2023.

(51) Int. Cl. F41G 3/08

(52) U.S. Cl. CPC F41G 3/08

(57) ABSTRACT

The present invention is generally directed to a Wind Speed Displaying Reticle System. In one embodiment, the Wind Speed Displaying Reticle System includes a Laser Beam Emitter that emits and projects a laser beam onto an intended target to facilitate measurement of distance and wind speed. The Wind Speed Displaying Reticle System also includes a Laser Beam Comparator that receives a reflected laser beam projected by the Laser Beam Emitter. The Laser Beam Comparator then determines the variance between a profile of the projected laser beam and a profile of the reflected laser beam. The Laser Beam Comparator also determines and analyzes wind effects on the reflected laser beam. The Wind Speed Displaying Reticle System further includes a Ballistic Calculator that receives wind effects data from the Laser Beam Comparator, and uses the wind effects data to calculate environmental effects data on a projectile's flight. In addition, the Wind Speed Displaying Reticle System includes a Look-Through Display that receives environmental effects data from the Ballistic Calculator, and presents the environmental effects data to the user.

### CROSS-REFERENCE TO RELATED APPLICATIONS

The present Application claims the benefit of U.S. Provisional Patent Application Ser. No. 63/445,479 filed on Feb. 14, 2023, the entire disclosure of which is incorporated herein in its entirety by reference.

### FIELD

This disclosure generally relates to a Wind Speed Displaying Reticle System.

### BACKGROUND

Small arms systems and firearms require the ability to determine wind speed. Wind speed is the most critical environmental variable on projectile flight. For example; if there is no wind when a firearm fires a projectile at a target, the projectile will go exactly to the set point of aim for that firearm.

Compensating for environmental variables is the most critical component to making accurate engagements with small arms. The measuring of other variables such as; Coriolis effect, barometric pressure, temperature can be quickly compensated for. This data can be provided by Ballistic Computers that provide accurate riflescope adjustments. This is possible for a no wind condition throughout the trajectory of the projectiles flight.

The disclosed Wind Speed Displaying Reticle System is a novel system that analyzes the characteristics of wind. It provides the shooter with wind effects on the trajectory of a projectile in a useable manner. The disclosed Wind Speed Displaying Reticle includes a series of sensors, calculators, and displays. This system was developed in order to determine wind speed, calculate its effects, provide wind data, and display its effects on the flight of the projectile in the shooters line of sight.

### BRIEF SUMMARY

The present invention is generally directed to a Wind Speed Displaying Reticle System. In one embodiment, the Wind Speed Displaying Reticle System includes a Laser Beam Emitter that emits and projects a laser beam onto an intended target to facilitate measurement of distance and wind speed. The Wind Speed Displaying Reticle System also includes a Laser Beam Comparator that receives a reflected laser beam projected by the Laser Beam Emitter. The Laser Beam Comparator then determines the variance between a profile of the projected laser beam and a profile of the reflected laser beam. The Laser Beam Comparator also determines and analyzes wind effects on the reflected laser beam. The Wind Speed Displaying Reticle System further includes a Ballistic Calculator that receives wind effects data from the Laser Beam Comparator, and uses the wind effects data to calculate environmental effects data on a projectile's flight. In addition, the Wind Speed Displaying Reticle System includes a Look-Through Display that receives environmental effects data from the Ballistic Calculator, and presents the environmental effects data to the user.

### BRIEF DESCRIPTION OF THE DRAWINGS

FIG. 1 is a diagram of the Wind Speed Displaying Reticle System attached to a scope according to one exemplary embodiment.

FIGS. 2A and 2B are diagrams showing the beam without interference and detectable atmospheric interference of the laser beams according to one exemplary embodiment.

FIGS. 3A and 3B are diagrams showing laser beams wave reflecting off of a target according to one exemplary embodiment.

FIGS. 4A, 4B, and 4C are diagrams of variations of the data displayed according to one exemplary embodiment.

### DETAILED DESCRIPTION

In general, wind speed and wind direction are the two primary causes of inaccuracy for engaging targets, especially at extended distances. The wind direction will push the projectile in the direction the wind is moving. If the wind is behind the shooter, the projectile will fly slightly higher over the trajectory. If the wind is from the front the projectile will fly slightly lower. When the wind comes from the side, it is important from what angle the wind is coming from. From a (90) ninety-degree angle, commonly called a full value wind, it has the most effect on the flight of the projectile. The wind will push the projectile off of its trajectory in the direction of the wind. If the wind direction is around (45) forty-five degrees, it would have half the effect. The wind speed directly correlates with the amount of travel off of the normal trajectory the projectile will take. The wind speed and wind direction have more of an effect closer to the firearm. This is because the deviations from the baseline trajectory have more of an exponential effect closer to the firearm.

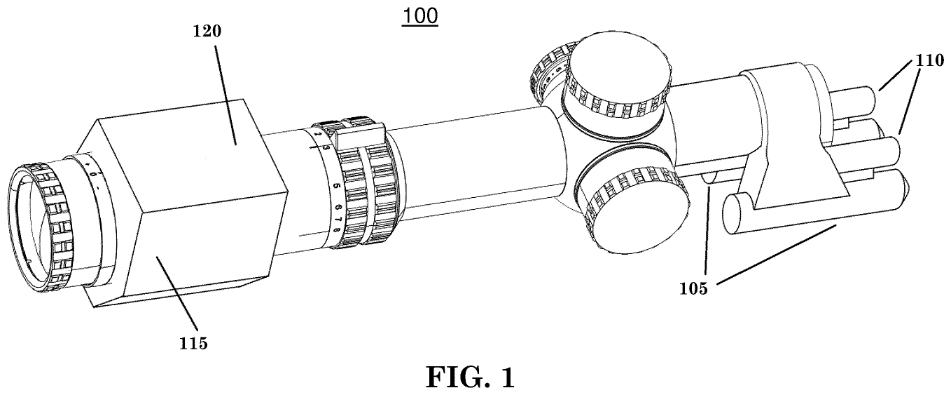

It is possible to determine wind speed through the use of an anemometer. This is a device that captures the air and through mechanical or electronic means and then determines wind speed and direction. An anemometer, standard within the art, may be used, in certain embodiments, within the disclosed Wind Speed Displaying Reticle System (shown as element 100 in FIG. 1). This is not the ideal embodiment as it requires equipment and actions that are not ideal, in particular in a combat or competition environment.

The disclosed Wind Speed Displaying Reticle System 100, in its ideal embodiment, uses one or more Laser Beam Emitters (shown as element 105 in FIG. 1) to determine wind speed. Through the use of calculating the disturbance caused by wind and particles in the wind, in a laser emission, it is possible to determine wind speed.

In general, there is a direct correlation between the disturbance in laser emissions and changes to projectile trajectory. Atmospheric disturbances on laser emissions are directly relatable to atmospheric disturbance on projectiles. In particular effects of wind speed between projectiles and beams of laser light are directly proportional. The atmospheric effects on laser beams are substantially smaller in scale, but generally equal to effects on projectiles, and can be measured. This capability is well within standard measurability with neodymium-doped yttrium aluminum garnet lasers, or ND-YAG lasers. These are the type most commonly found in laser rangefinders. Many lasers (such as ND-YAG) lasers operate in both pulsed and continuous mode. The disclosed Precision Wind Speed Displaying Reticle System can utilize either or both pulsed and continuous lasers.

The atmospheric effects of wind, when measured by the laser is a direct correlation of the same atmospheric effects on the projectile. The laser beam emission will be disturbed by wind effects and this can be measured. This disturbance of the laser beam is related to the effects of small particles in the air. It is by measurement of these beam disturbances that wind speed effects can be calculated.

For particles to have an effect on the laser beam, they must be larger than the wavelength of the laser. ND-YAG lasers commonly emit in the 1064, 946, 1120, 1320, and 1440 Nanometer ranges. Through pulsing in high power modes, the frequency can be doubled to emit in 532 nm. In some cases higher harmonics at 355, 266 and 213 nm are possible. Since most particles in the air are larger than that size, their effects will be easy to measure. Common sizes of aerosolized dust are between 1 and 100 micrometers. These beam disturbances are an ideal measurement to determine atmospheric effects on ballistic projectiles in flight. This data will be cataloged for each of the laser types and associated specific atmospheric effects on projectile trajectory. Particles deflect and reflect light traveling through air. This deflection, or shift, is detected as disturbances in beam wavelength consistency, color, and vibrance. This changes with the speed and direction of particles in the air. This method would require the calibration of wavelength disturbances to corresponding wind speed. Subsequently, these wind effect patterns on laser beam disturbances, or shift, will be converted into mathematic algorithms. It is common to filter these atmospheric disturbances in laser beams, at the laser beam apertures, using Spatial Filters. In one embodiment, the beam disturbances would be measured by a light sensitive device incorporated with the Spatial Filter on a laser beam emitter aperture.

The beam disturbances would be constantly monitored and compared. The disturbance pattern would be recorded and compared with previous and subsequent disturbance patterns. This recording or cataloging would provide data profiles for the calculation of the wind effects on the projectile. This would ultimately be compared to other cataloged data sets that would assist in providing the most closely aligned pattern. These data streams would be matched to the closest wind speed profile.

The ideal embodiment would use multiple laser beam emitters set a certain distance apart from each other. As one beam is disturbed by particles, eventually the other laser beams would be disturbed by a similar particle pattern. For example, if two beams were set in tandem, then the beam to the left was disturbed and the beam to the right, this would show the wind direction was from the left and moving to the right. This beam disturbance pattern will accurately calculate wind direction.

The particle disturbance would interrupt one beam. The particles would travel the distance between the Laser Beam Emitters 105. The particles would then disturb the other laser beam, the time for the disturbance pattern to travel the distance between the laser beams would allow for the calculation of wind speed.

Another method is the beam would project an image, such as a diamond. The variation in clarity and direction of the distortion would be used to calculate wind effects. This would be a method where the use of an optical comparator in conjunction with, or in place of a Laser Beam Comparator (shown as element 110 in FIG. 1).

The use of particle patterns and recognition of the patterns between each of the beam emitters, would be a method to provide highly detailed measurements. This is the purpose of having the Laser Beam Comparator 110. In one embodiment, this would be a component within the Laser Beam Emitter 105 and closely linked to the Ballistic Calculator (shown as element 120 in FIG. 1). In one embodiment, the Laser Beam Comparator 110 would receive the return of the laser beam emitted by the Laser Beam Emitter 105, and would be able determine atmospheric effects between the baseline emission and the beam on return. In one embodiment, the Laser Beam Comparator 110 could be a purely optical comparator that is able to detect wind disturbances with the use of laser beam emissions. The disturbance in air patterns is detectable with camera, infra-red, or other optical equipment. This disturbance is often called “mirage” the same method of disturbance detection could be used to determine wind speed.

The distance away from the emitter that the beam is disturbed would be proportional to the amount of actual disturbance detected. This would have a directly proportional effect on the projectile's flight. A commonly used wind effect formula is the Hodnett quick wind formula. This states the range in 1000-meter increments is multiplied by the result of the speed of the wind in meters divided by the ballistic coefficient. This provides the shooter the adjustment for wind in milliradians. (Range in 1000 meters X (wind/BC)=mil radian wind adjustment). For example, the wind disturbance at 500 meters for a projectile in 5 meter per second wind with a 0.5 Ballistic coefficient is (0.5× (2.5))=1.25 mil radian adjustment. This also roughly equal to wind disturbance at 1000 meters for the same projectile in 2 meter per second wind. (1× (1.25))=1.25 mil radian adjustment.

Beam disturbance at various distances would have correlated wind effects on the projectile's trajectory. Beam disturbance detected at further distances will be less detectable than disturbances at closer distances. This correlates with wind of similar speeds but at further distances having less effects on projectile trajectory. This would provide a simpler solution to calculate effects on projectile trajectory. This beam disturbance data will be used to calculate wind effects consistent with ballistic information on projectile flight. This beam disturbance algorithm matrix will be further incorporated into standard ballistic calculators common in the art.

This enables beam disturbance patterns and the correlating effects on projectiles to be calculated by real time environmental data. This data once incorporated into ballistic calculators provide the specific data on wind effects on projectiles. Ballistic Calculators 120 are systems and devices in common use. The disclosed Wind Speed Displaying Reticle System 100 would utilize common ballistic calculator interfaces and methods. The resultant data would be further calculated into the specific requirements of the Look-Through Data Display (shown as element 115 in FIG. 1). The data display could be an electronically managed device that allows the shooter to see the needed adjustments to the point of aim.

In one embodiment, the data display information will be displayed electronically within the line of sight to the shooter. The wind speed would be shown in a numerical manner. This would require the shooter to make adjustments for projectile flight on their own. In an ideal embodiment, the wind effects would be displayed in the optic, on the scope reticle, in manner common in the art, within the shooters line of sight. The disclosed Wind Speed Displaying Reticle System 100 would provide real time wind effect data. This would include changes to the point of impact, caused by wind, for the shooter.

In one embodiment, the disclosed Wind Speed Displaying Reticle System 100 analyzes the characteristics of wind. It then provides the shooter with data in a useable manner. The disclosed Wind Speed Displaying Reticle System 100 includes a series of sensors, calculators, and displays. In general, the system 100 is developed in order to determine wind speed, calculate its effects, provide wind data, and display its effects on the flight of the projectile in the shooters line of sight within the riflescope.

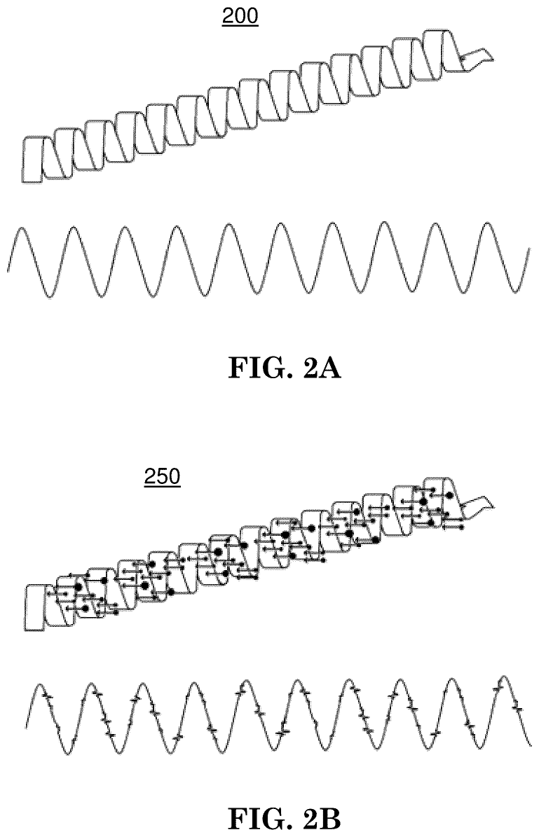

With reference to FIGS. 1-4, the present invention may be described. FIG. 1 is a diagram of the Wind Speed Displaying Reticle System 100 attached to a scope according to one exemplary embodiment. As shown in FIG. 1, a multiple beam Laser Emitter 105 and the Laser Beam Comparators 110 attached to the front. FIG. 1 also shows the scope is rear attached external Look Though Display 115 and also contains the Ballistic Calculator 120. FIGS. 2A and 2B are diagrams showing the beam without interference and detectable atmospheric interference of the laser beams according to one exemplary embodiment.

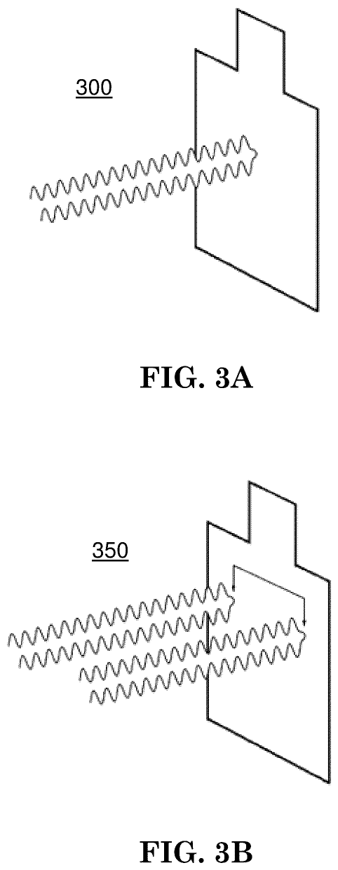

FIGS. 3A and 3B are diagrams showing beam wave reflecting off of a target according to one exemplary embodiment. FIG. 3A shows a single beam configuration 300, which shows measurement of the beam disturbance during emission and reflection. FIG. 3B shows a multiple beam configuration 350 that adds averaging disturbance measurement over a set distance apart to increase wind speed measurement accuracy.

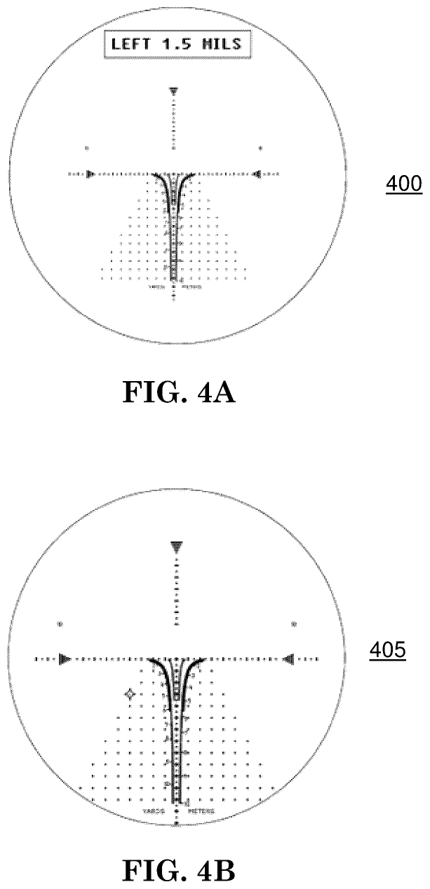

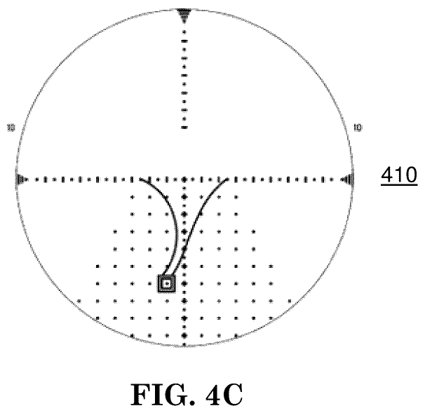

FIGS. 4A, 4B, and 4C are diagrams of variations of the data displayed 400, 405, and 410 according to one exemplary embodiment. FIG. 4A shows numeric. FIG. 4B shows point of impact. FIG. 4C shows trajectory arcs. U.S. Pat. No. 10,073,277, entitled “TRAJAECTORY COMPENSATING RETICLE FOR ACCURATE ENGAGEMENT OF A TARGET AT AN UNKNOWN DISTANCE”, is directed to a reticle for use with a scope of a firearm that allows the user of the firearm to compensate for bullet drop for the entire bullet trajectory.

In one embodiment, the disclosed Wind Speed Displaying Reticle System 100 has four primary components, including a Laser Beam Emitter 105, a Laser Beam Comparator 110, a Ballistic Calculator 120, and a Look-Through Data Display 115. In general, the Laser Beam Emitter 105 projects a laser beam onto the intended target. This provides both beam use for distance and wind speed measurements. Wind speed measurements are determined by measuring the interruption by particles in the air of the laser beam. The Laser Beam Comparator 110 determines variance between the uninterrupted beam profile and the actual reflected beam data. It also provides wind pattern data algorithms to correlate to the wind effects on the beam, for the distance to target as calculated. Ballistic Calculator 120 is a device that provides trajectory, wind effect data, Coriolis effect, barometric pressure, temperature, and other environment factors, which are calculated for their effect on the projectile. The Look-Through Data Display 115 provides the data to the shooter in their line of sight. It may show both a numerical output and/or an exact point of impact based on the output of the Ballistic Calculator 120.

The Laser Beam Emitter 105 is the component of the system responsible for the projection of the laser beam. Although these devices by themselves are in common use and are not proprietary in their nature, the disclosed Wind Speed Displaying Reticle System 100 employs the devices to support multiple proprietary concepts. One proprietary element is the optimization of the beam emitter 105 for maximizing the detection of atmospheric disturbances. This may be accomplished by manipulating components of the emitter such as color of the beam, beam pattern, beam frequency, or beam pattern disturbance filtration to provide better return signal of atmospheric disturbances.

The frequency and pulse pattern of the beam is a key element in detecting and measuring atmospheric disturbances. One specific proprietary element of the disclosed Wind Speed Displaying Reticle System 100 is the spacing of the multiple beam emitters at a set distance apart to provide and even more accurate measurement of atmospheric disturbances. In one embodiment, emitters are set at a known distance apart from one another, most likely in a horizontal arrangement. Of note, the beam emitters may need the ability to traverse upward in elevation, to specifically measure wind disturbances in the higher elevations of the projectile's trajectory. For example, these emitters are set at 50 millimeters apart. If the wind direction is from the right to the left at 5 mph, the left emitter will detect the pattern and intensity of the disturbance. The disturbance would then travel across the 50 mm space between emitters. The disturbance would then be detected by the emitter on the right. The beam disturbance pattern and intensity would not only provide data for the atmospheric conditions but so would the second. This would provide an average between the emitters for an increase in accuracy. An additional level of accuracy would then be provided by the distance between emitters and the time it took the atmospheric disturbance pattern to travel that set distance.

The Laser Beam Comparator 110 is an important component to the system. In general, the Laser Beam Comparator 110 is the device responsible for calculating the atmospheric disturbance in the Laser Beam. It is critical to be able to determine the atmospheric effects on beam emissions. The Laser Beam Comparator 110 receives the reflected laser beam signal. The Laser Beam Comparator 110 then determines the variance between the reflected beam pattern and base line beam pattern. The difference in the patterns is the level of atmospheric disturbance. The ability to receive this signal is in within common use of laser range finding equipment in broad application today.

The Laser Beam Comparator 110 will be essential in wind particle disturbance algorithm development. This device allows the process of determining the baseline values of laser emissions at set ranges without atmospheric effects. This is already a well-established process in common use with laser rangefinders. The disclosed Wind Speed Displaying Reticle System 100 utilizes the disturbance in laser beam patterns, which is commonly filtered out using a Spatial Filter on the laser beam apertures. These disturbances are detected, at set distances, at determined wind speeds, in order to establish a data matrix for atmospheric effects. This data is then utilized with ballistic data information in common use. This data allows for the calculations necessary for adjustments caused by atmospheric effects on projectile trajectory.

It is possible to determine the atmospheric effects with a single beam emitter 105. A single beam emission will provide one data set. It will require multiple emissions to determine the pattern shift from base line. The more emissions provide more data points. Based on the data matrix, a pattern of atmospheric disturbance will begin to appear as more emissions are inspected. Pulsed laser beam emissions directly compared to each other maybe an ideal solution for a single emitter.

The accuracy is further increased by using multiple Laser Beam Emitters 105 and Comparators 110. The same technique as a single beam could be used. With multiple devices the ability to average the results from each would provide a more accurate solution. The proprietary method of using two emitters and comparators at set distances from each other, then calculating the time over that distance the disturbance patterns traveled, would be directly proportional to actual wind speed. Accurate measurement of disturbance pattern travel over a set distance would provide an even higher level of accuracy.

Beam interference calibration is an important aspect of the system. There would be not only a default calibration setting but the ability to alter the baseline settings. Factors such as precipitation, fog, elevation, and other adverse conditions would have to be accounted for. The method of determining variations in emitted and reflected beams and their disturbance patterns is another novel aspect and is not utilized in any other known device. In one embodiment, a light sensitive device is used on the Laser Beam Emitter, at the aperture of the laser, that would detect the beam disturbance removed by a Spatial Filter.

The Ballistic Calculator 120 is a device in common wide spread use. This device determines effects on projectile trajectory and provides this information to the shooter or to the Look-Through Display 115. In one embodiment, the Look-Through Display 115 may not be required as many Ballistic Calculators 120 have a display. The ideal embodiment would transmit data from the Ballistic Calculator 120 to the Look-Through Display 115. The Ballistic Calculator 120 would receive data from the Laser Beam Comparator 110 that would allow for adjustment for atmospheric effects to be compensated for.

In one embodiment, the disclosed Wind Speed Displaying Reticle System 100 includes a Look-Through Data Display 115, which is generally a device that is attached to the firearms optic, or an internal part of the optic, that provides displayed information in the line of sight of the shooter. This allows the shooter to engage targets faster and more effectively. This is done by displaying target engagement information to the shooter without them having to look away. Estimation of effects of wind on projectile trajectory is the most difficult to determine. Shooters (or users) often have to look away from the target to calculate wind speed increasing the possibility missing the target. Ideal embodiments would provide trajectory changes in real time, in the line of sight of the shooter. FIGS. 4A, 4B, and 4C show anticipated information displays 400, 405, and 410 that ideally would be combined in accordance with an exemplary embodiment.

Insofar as the description above and the accompanying drawings disclose any additional subject matter that is not within the scope of the single claim below, the inventions are not dedicated to the public and the right to file one or more applications to claim such additional inventions is reserved.

The novel aspects and claims of the present Wind Speed Displaying Reticle System may include one or more of the following concepts:
The process of using the electronic observation and measurement of the effects of wind and wind-borne particles on light waves for determining wind speed.
The process of amplifying laser light waves to enhance the detection of effects of wind and wind-borne particles on light waves for determining wind speed.
The use of continuous and pulsing laser emissions to enhance the detection of effects of wind and wind-borne particles on light waves for determining wind speed.
The process of using multiple laser light emitters to enhance the detection of effects of wind and wind-borne particles on light waves for determining wind speed.
The use of electronic comparators to determine the effects of wind and wind-borne particles on light waves for determining wind speed.
The use of disturbance pattern data streams that is compared to previous pattern information. This is collected and compared to a database for assisting with wind speed calculations.
The separation of multiple emitters, at a set distance, to aid in the calculation of wind speed.
The directional traversing of laser beam emitters to calculate wind effected in specific portions of the projectile's trajectory.
The process of using the effects of wind and wind-borne particles on light waves for determining wind speed and correlating this to wind effects on projectiles.
The process of calibrating a device for the detection of wind and wind-borne particles and their effects on light waves for determining effects on projectile trajectory.
The process converting these atmospheric effects on light waves into data and then into a digital representation of this data.
The use of a light sensitive device on or around the Spatial Filter, at the aperture of the Laser Beam Emitter, that would detect, and catalog the beam disturbance removed by the spatial filter.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

We claim:

1. A wind speed displaying reticle system, comprising:
a laser beam emitter that emits and projects a laser beam onto an intended target to facilitate measurement of distance and wind speed;
a laser beam comparator that receives a reflected laser beam that is a reflection of the laser beam emitted and projected by the laser beam emitter, determines a variance between a profile of the projected laser beam and a profile of the reflected laser beam, and determines and analyzes wind effects on the projected laser beam;
a ballistic calculator that receives wind effects data from the laser beam comparator, and uses the wind effects data to calculate environmental effects data on a projectile's flight; and
a look-through display that receives environmental effects data from the ballistic calculator, and presents the environmental effects data to a user.

2. The wind speed display reticle system of claim 1, wherein the measurement of wind speed is determined by measuring interruption of particles in the emitted and projected laser beam.

3. The wind speed display reticle system of claim 1, wherein the laser beam emitter is manipulated to emit and project laser beams of different beam colors, beam patterns, beam frequencies, and/or beam pattern disturbance filtration to provide improved return signal of atmospheric disturbances.

4. The wind speed display reticle system of claim 1, wherein the laser beam emitter emits pulsed laser beams.

5. The wind speed display reticle system of claim 1, wherein a variance between a profile of the emitted and projected laser beam and a profile of the reflected laser beam is caused by an atmospheric disturbance.

6. The wind speed display reticle system of claim 1, wherein the ballistic calculator includes the wind effect data, trajectory information, Coriolis effect, barometric pressure, and temperature to calculate an effect on the projectile.

7. The wind speed display reticle system of claim 1, further comprising a light sensitive device placed on or around a spatial filter at an aperture of each laser beam emitter, wherein the light sensitive device detects and catalogs beam disturbance removed by the spatial filter.

8. A wind speed displaying reticle system, comprising:
a plurality of laser beam emitters, wherein each laser beam emitter emits and projects a laser beam onto an intended target to facilitate measurement of distance and wind speed;
a plurality of a laser beam comparators, wherein each laser beam comparator receives a reflected laser beam that is the reflection of the laser beam emitted and projected by each laser beam emitter, determines a variance between a profile of the projected laser beam and a profile of the reflected laser beam, and determines and analyzes wind effects on the projected laser beam;
a ballistic calculator that receives wind effects data from the plurality of laser beam comparators, and uses the wind effects data to calculate environmental effects data on a projectile's flight; and
a look-through display that receives environmental effects data from the ballistic calculator, and presents the environmental effects data to a user.

9. The wind speed display reticle system of claim 8, wherein the measurement of wind speed is determined by measuring interruption of particles in the emitted and projected laser beams.

10. The wind speed display reticle system of claim 8, wherein each laser beam emitter is manipulated to emit and project laser beams of different beam colors, beam patterns, beam frequencies, and/or beam pattern disturbance filtration to provide improved return signal of atmospheric disturbances.

11. The wind speed display reticle system of claim 8, wherein each laser beam emitter emits pulsed laser beams.

12. The wind speed display reticle system of claim 8, wherein a variance between a profile of the emitted and projected laser beam and a profile of the reflected laser beam is caused by an atmospheric disturbance.

13. The wind speed display reticle system of claim 8, wherein the ballistic calculator includes the wind effect data, trajectory information, Coriolis effect, barometric pressure, and temperature to calculate an effect on the projectile.

14. The wind speed display reticle system of claim 8, further comprising a light sensitive device placed on or around a spatial filter at an aperture of each laser beam emitter, wherein the light sensitive device detects and catalogs beam disturbance removed by the spatial filter.
